(19) United States
(12) Patent Application Publication
(10) Pub. No.: US 2026/0162073 A1
(43) Pub. Date: Jun. 11, 2026

(54) ELECTRIC VEHICLE CHARGING WITH EXTENDED REALITY

(71) Applicant: Ford Global Technologies, LLC, Dearborn, MI (US)

(72) Inventors: Dominique Meroux, Ann Arbor, MI (US); Kai Wu, Pittsburgh, PA (US); Hyongju Park, Ann Arbor, MI (US); Ruthwik Reddy Junuthula, Farmington Hills, MI (US); Chen Zhang, South Lyon, MI (US)

(73) Assignee: Ford Global Technologies, LLC, Dearborn, MI (US)

(21) Appl. No.: 18/969,343

(22) Filed: Dec. 5, 2024

(51) Int. Cl. G06Q 10/20; B60L 53/66; B60L 53/67

(52) U.S. Cl. CPC G06Q 10/20; B60L 53/665; B60L 53/67

(57) ABSTRACT

A computer includes a processor and a memory, and the memory stores instructions executable by the processor to track a sequence of steps of charging an electric vehicle (EV) by electric vehicle service equipment (EVSE), execute a large-language model (LLM) to generate handling operations for a user to handle components of the EVSE, and output the handling operations to an extended-reality (XR) device. The handling operations support the steps of charging the EV. The XR device displays the handling operations overlaid on the EVSE. The XR device highlights the components of the EVSE that are in the handling operations.

### BACKGROUND

Electric vehicles require batteries to be recharged, which can be done at public charging stations. Technology is emerging for the architecture and operation of charging station systems. For example, charging station systems can include various types of charging stations such as Level 1 chargers, Level 2 chargers, Direct current fast chargers (DCFC), etc. Level 1 charges can use a 120-volt alternating current (AC) outlet, which can charge a vehicle from 0% state of charge to 80% state of charge (i.e., a relative value indicating how much energy remains in the battery compared to a maximum capacity) in 40-50 hours (e.g., based on a 40-50 kWh battery). Level 2 chargers can use a 240-volt AC outlet, which can charge a vehicle from 0% state of charge to 80% state of charge in 4-10 hours. DCFC can use a direct current (DC) outlet, which can charge a vehicle from 0% state of charge to 80% state of charge in 1 hour or less.

### BRIEF DESCRIPTION OF THE DRAWINGS

FIG. 1 is a block diagram of an example system including an electric vehicle.

FIG. 2 is a diagram of an example charging site at which the electric vehicle is charging.

FIG. 3 is a perspective view in an example extended-reality output of handling operations for charging the electric vehicle at the charging site.

FIG. 4 is a flowchart of an example process for charging the electric vehicle at the charging site.

FIG. 5 is a flowchart of an example process for addressing a fault during the charging.

### DETAILED DESCRIPTION

This disclosure provides techniques for a user to correctly use or troubleshoot issues with an electric vehicle service equipment (EVSE) for charging an electric vehicle (EV). A computer is programmed to track a sequence of steps of charging the EV by the EVSE, execute a large-language model (LLM) to generate handling operations for the user to handle components of the EVSE, and output the handling operations to an extended-reality (XR) device. The handling operations support the steps of charging the EV. The XR device displays the handling operations overlaid on the EVSE. The XR device highlights the components of the EVSE that are in the handling operations. The XR device may provide output in virtual reality or augmented reality. The XR device may be used by the operator of the EV for charging the EV, by a repair technician for repairing or troubleshooting the EVSE, or by a call-center technician to instruct the EV operator about charging the EV. Using an LLM can provide handling operations for a wide variety of circumstances. The output by the XR device provides a technological means for pointing the user to the correct components for the handling operations, when the user may be unfamiliar with the EVSE (such as an operator charging their EV at a public charging station for the first time) or when the components of the EVSE may be complex (such as a technician troubleshooting internal components of the EVSE). These techniques can provide the user with a greater likelihood of success even without any additional knowledge on the part of the user.

A computer includes a processor and a memory, and the memory stores instructions executable by the processor to track a sequence of steps of charging an electric vehicle (EV) by electric vehicle service equipment (EVSE), execute a large-language model (LLM) to generate handling operations for a user to handle components of the EVSE, and output the handling operations to an extended-reality (XR) device. The handling operations support the steps of charging the EV. The XR device displays the handling operations overlaid on the EVSE. The XR device highlights the components of the EVSE that are in the handling operations.

In an example, the sequence of steps may include a fault that interrupts the charging of the EV by the EVSE, and at least one of the handling operations may be responsive to the fault.

In an example, the XR device may be an augmented-reality (AR) device, and the AR device may display the handling operations overlaid on a real-time display of the components of the EVSE.

In an example, the instructions may further include instructions to determine a role of the user with respect to the EVSE, and the LLM may generate the handling operations specific to the role of the user. In a further example, the instructions may further include instructions to select the role from a preset group including at least EV operator and repair technician. In a yet further example, at least some of the handling operations specific to the repair technician may relate to the components of the EVSE that are inaccessible to the EV operator.

In another yet further example, the preset group may include call-center technician.

In an example, the instructions may further include instructions to, in response to a location of the user being at the EVSE, output the handling operations in augmented reality.

In an example, the instructions may further include instructions to, in response to a location of the user being away from the EVSE, output the handling operations in virtual reality.

In an example, the instructions may further include instructions to, in response to receiving a selection of the EVSE while the user is located away from the EVSE, transmit a message to the EVSE instructing the EVSE to perform a subset of the sequence of steps. In a further example, the subset may include processing payment data for the user.

In another further example, the instructions may further include instructions to, in response to receiving an indication of a fault in performing the subset, display a plurality of alternative EVSEs.

In an example, the LLM may be trained on training data that includes technical documentation of the EVSE.

In an example, the instructions may further include instructions to, in response to receiving a selection of the EVSE from a plurality of EVSEs, track the sequence of steps of charging the EV by the EVSE.

A method includes tracking a sequence of steps of charging an electric vehicle (EV) by electric vehicle service equipment (EVSE), executing a large-language model (LLM) to generate handling operations for a user to handle components of the EVSE, and outputting the handling operations to an extended-reality (XR) device. The handling operations support the steps of charging the EV. The XR device displays the handling operations overlaid on the EVSE. The XR device highlights the components of the EVSE that are in the handling operations.

In an example, the sequence of steps may include a fault that interrupts the charging of the EV by the EVSE, and at least one of the handling operations may be responsive to the fault.

In an example, the method may further include determining a role of the user with respect to the EVSE, and the LLM may generate the handling operations specific to the role of the user. In a further example, the method may further include selecting the role from a preset group including at least EV operator and repair technician.

In an example, the method may further include, in response to a location of the user being at the EVSE, outputting the handling operations in augmented reality.

In an example, the method may further include, in response to a location of the user being away from the EVSE, outputting the handling operations in virtual reality.

With reference to the Figures, wherein like numerals indicate like parts throughout the several views, a computer 105, 110, 115 includes a processor and a memory, and the memory stores instructions executable by the processor to track a sequence of steps of charging an electric vehicle (EV) 100 by electric vehicle service equipment (EVSE) 205, execute a large-language model (LLM) to generate handling operations for a user to handle components 305 of the EVSE 205, and output the handling operations to an extended-reality (XR) device 115. The computer 105, 110, 115 may be a vehicle computer 105 of the EV 100, a remote computer 110 distinct from the EV 100, and/or the XR device 115. The handling operations support the steps of charging the EV 100. The XR device 115 displays the handling operations overlaid on the EVSE 205. The XR device 115 highlights the components 305 of the EVSE 205 that are in the handling operations.

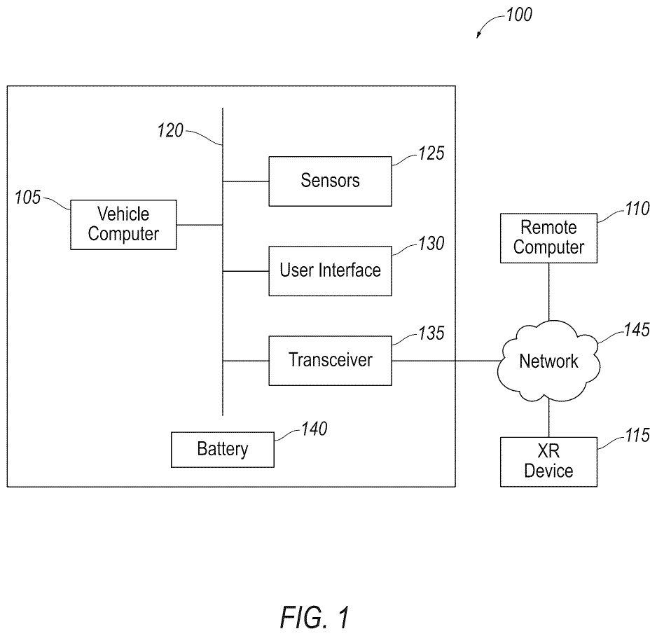

With reference to FIG. 1, the EV 100 may be any passenger or commercial automobile such as a car, a truck, a sport utility vehicle, a crossover, a van, a minivan, a taxi, a bus, etc. The EV 100 may be a plug-in hybrid electric vehicle (PHEV), battery electric vehicle (BEV), or extended-range BEV. The EV 100 includes the vehicle computer 105, a communications network 120, sensors 125, a user interface 130, a transceiver 135, and a battery 140.

The battery 140 provides power (i.e., electricity) to components of the EV 100. Specifically, the battery 140 provides power for propulsion of the EV 100, that is, for the EV 100 to move itself around. The battery 140 may be of any suitable type for vehicular electrification, for example, lithium-ion batteries, nickel-metal hydride batteries, lead-acid batteries, or ultracapacitors, as used in, for example, PHEVs or BEVs. The battery 140 may be multiple batteries or cells wired together.

The vehicle computer 105 is a microprocessor-based computing device such as a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design to describe digital and mixed-signal systems such as FPGA and ASIC. For example, an ASIC is manufactured based on VHDL programming provided pre-manufacturing, whereas logical components inside an FPGA may be configured based on VHDL programming (e.g., stored in a memory electrically connected to the FPGA circuit). The vehicle computer 105 can thus include a processor, a memory, etc. The memory of the vehicle computer 105 can include media for storing instructions executable by the processor as well as for electronically storing data and/or databases, and/or the vehicle computer 105 can include structures such as the foregoing by which programming is provided. The vehicle computer 105 can be multiple computers coupled together.

The vehicle computer 105 may transmit and receive data through the communications network 120. The communications network 120 may be a controller area network (CAN) bus, Ethernet, WiFi, Local Interconnect Network (LIN), onboard diagnostics connector (OBD-II), and/or any other wired or wireless communications network. The vehicle computer 105 may be communicatively coupled to the sensors 125, the user interface 130, the transceiver 135, and other components via the communications network 120.

The sensors 125 may provide data about operation of the EV 100, for example, wheel speed, wheel orientation, and transmission data (e.g., temperature, power consumption, state of charge of the battery 140, etc.). The sensors 125 may detect the location and/or orientation of the EV 100. For example, the sensors 125 may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors 125 may detect the external world, including objects and/or characteristics of surroundings of the EV 100, such as other vehicles, road lane markings, traffic lights and/or signs, road users, etc. For example, the sensors 125 may include radar sensors, ultrasonic sensors, scanning laser range finders, light detection and ranging (lidar) devices, and image processing sensors such as cameras.

The user interface 130 presents information to and receives information from an operator of the EV 100. The user interface 130 may be located on an instrument panel in a passenger compartment of the EV 100, and/or wherever may be readily seen by the operator. The user interface 130 may include dials, digital readouts, screens, speakers, and so on for providing information to the operator, such as human-machine interface (HMI) elements such as are known. The user interface 130 may include buttons, knobs, keypads, microphone, and so on for receiving information from the operator.

The transceiver 135 may be adapted to transmit signals wirelessly through any suitable wireless communication protocol, such as cellular, Bluetooth®, Bluetooth® Low Energy (BLE), ultra-wideband (UWB), WiFi, IEEE 802.11a/b/g/p, cellular-V2X (CV2X), Dedicated Short-Range Communications (DSRC), other RF (radio frequency) communications, etc. The transceiver 135 may be adapted to communicate with a remote server, that is, a server distinct and spaced from the vehicle. The remote server may be located outside the EV 100. For example, the remote server may be associated with another vehicle (e.g., V2V communications), an infrastructure component (e.g., V2I communications), a first responder, a mobile device associated with the operator of the EV 100, etc. The remote server may be the remote computer 110, the XR device 115, or the EVSE 205. The transceiver 135 may be one device or may include a separate transmitter and receiver.

The vehicle computer 105, the remote computer 110, and/or the XR device 115 may be communicatively coupled via a network 145. The network 145 represents one or more mechanisms by which the vehicle computer 105, the remote computer 110, and/or the XR device 115 may communicate with each other or with other remote servers. Accordingly, the network 145 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, IEEE 802.11, etc.), local area networks (LAN) and/or wide area networks (WAN), including the Internet, providing data communication services.

The remote computer 110 is a microprocessor-based computing device such as a generic computing device including a processor and a memory. The memory of the remote computer 110 can include media for storing instructions executable by the processor as well as for electronically storing data and/or databases, and/or the remote computer 110 can include structures such as the foregoing by which programming is provided. The remote computer 110 can be multiple computers coupled together. For example, the remote computer 110 may be a mobile device. The mobile device is a portable computing device such as a mobile phone (e.g., a smartphone) or a tablet. The mobile device is owned and carried by a person who may be the operator of the EV 100 or who may be a technician servicing the EVSE 205. For another example, remote computer 110 may be associated with a service center or call center overseeing the EVSE 205.

The XR device 115 is a device equipped to provide an output in extended reality. Extended reality combines the physical world with a digital world that interacts with the physical world within the extended reality. Extended reality includes augmented reality, virtual reality, and mixed reality. Augmented reality combines the real world and computer-generated content superimposed on the real world from the point of view of the user. Virtual reality provides a computer-generated simulation of the physical world to the user, possibly combined with additional digital features. Mixed reality is a combination of augmented reality and virtual reality.

For example, the XR device 115 may be an augmented-reality (AR) device such as AR glasses, a portable computing device such as a mobile phone (e.g., a smartphone) or a tablet equipped for AR output, or a display in the EV 100 such as a heads-up display (HUD) (e.g., as part of the user interface 130). The AR glasses have transparent lenses that permit the user to see their surroundings. The lenses of the AR glasses also display content, which the user sees at the same time as viewing the world through the lenses. The AR glasses may display content at a size and location on the lenses so that the content appears to the user to be at a specific location in the world. For example, the AR glasses may use pose tracking to determine the position and orientation of the user's head with respect to the surroundings (e.g., based on data from inertial measurement units (IMUs) or the like). The portable computing device may include a camera and a screen. The portable computing device may display image data from the camera on the screen along with content at a size and location on the image data so that the content appears to the user to be at a specific location in the world. The portable computing device may use pose tracking to determine its position and orientation. The HUD may display information or graphics on a windshield of the EV 100, which is transparent and permits the user to see the surroundings of the EV 100. The HUD may display content at a size and location on the lenses so that the content appears to the user to be at a specific location in the world. For example, the HUD may use data from the sensors 125 to track the pose of the EV 100 with respect to the surroundings.

The XR device 115 includes a microprocessor-based computing device such as a generic computing device including a processor and a memory. The memory of the XR device 115 can include media for storing instructions executable by the processor as well as for electronically storing data and/or databases, and/or the XR device 115 can include structures such as the foregoing by which programming is provided. The XR device 115 can include multiple computers coupled together.

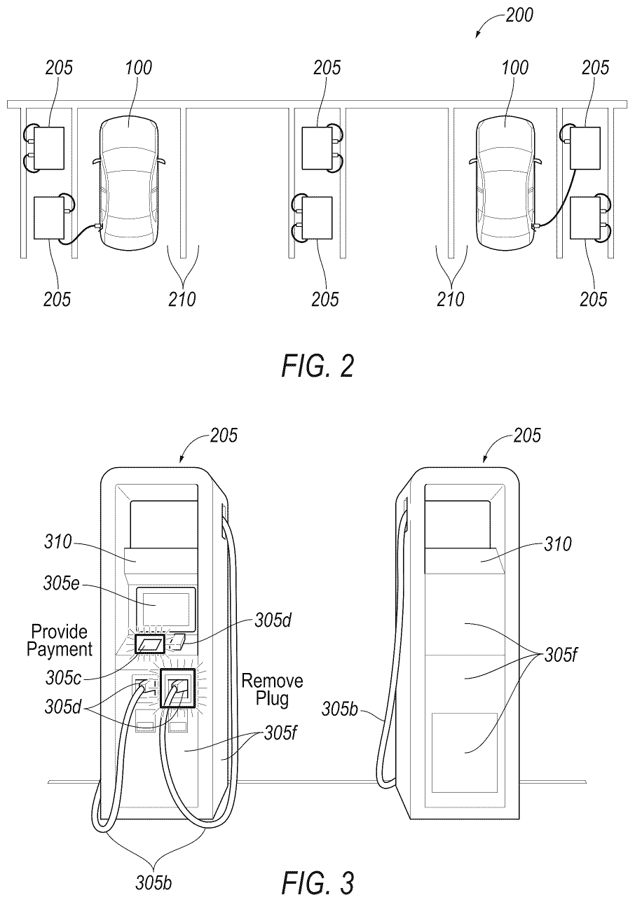

With reference to FIG. 2, a charging site 200 may include one or a plurality of the EVSEs 205. An area encompassed by the charging site 200 can be defined (e.g., as a perimeter) on which the EVSEs 205 and other elements of the charging site 200 are located. The charging site 200 can include one or more parking spaces 210 corresponding to respective EVSEs 205. That is, the parking spaces 210 are provided as areas in which an EV 100 can be parked while receiving electrical charge for the battery 140 from a respective EVSE 205. The charging site 200 can also include a region in which EVs 100 may park and/or travel (e.g., while awaiting access to one of the EVSEs 205) to park to visit some other facility of the charging site 200, to enter and exit the charging site 200, etc. The areas of the charging site 200, and any other regions thereof, can be defined according to location coordinates, a geo-fence, or any other suitable manner of defining location boundaries.

Each EVSE 205 is equipped to charge the battery 140 of an EV 100. The EVSE 205 can typically charge one EV 100 at a time. The EVSE 205 draws power from an electrical grid to transfer to the battery 140 of the EV 100. The EVSE 205 is typically stationary (i.e., fixed to and not able to move from a specific physical location). The respective one or more EVSEs 205 in the charging site 200 can use any suitable mechanism for recharging the battery 140 of the EV 100 (e.g., a plug-in connection, inductive charging, etc.). A plug-in connection involves connecting a plug 305a of the EVSE 205 (shown in FIG. 3) to a port of the EV 100. Inductive charging is a form of wireless power transfer relying on electromagnetic induction. The components 305 for the power transfer may be located underneath the parking space 210 corresponding to the EVSE 205.

With reference to FIG. 3, the EVSE 205 may include a physical structure 310 on which the components 305 of the EVSE 205 are mounted or connected. For the purposes of this disclosure, a “component” of the EVSE 205 is defined as any physical part of the EVSE 205 that a user is able to manipulate or interact with. The components 305 may include external components, which may be visible to operator of an EV 100 that uses the EVSE 205, as well as internal components, which may be hidden by one or more panels 305f of the EVSE 205. The external components may include one or more plugs 305a, one or more cables 305b leading to the respective plugs 305a, a payment device 305c such as a credit card reader, a keypad 305d or other input device for entering data, a screen 305e for displaying information, the panels 305f, etc. Internal components (not shown) may include wiring, circuit boards, transformers, computing devices, and other electrical or computing components for transferring power and processing data to facilitate transferring power.

To charge the EV 100 with the EVSE 205, the operator and the EVSE 205 together perform a sequence of steps of charging the EV 100 by the EVSE 205. The steps may encompass steps for delivering payment from the operator of the EV 100 to the operator of the EVSE 205, selecting a charging protocol, transferring power from the EVSE 205 to the EV 100, and terminating the charging. For example, when no faults occur, the steps actually performed may follow an intended sequence of steps. The intended sequence of steps includes initiating the charging by the operator providing an input to the EVSE 205, outputting an instruction to provide payment by the EVSE 205, inputting payment information by the operator, receiving payment information by the EVSE 205, verifying the payment information by the EVSE 205, outputting an instruction to select a charging protocol by the EVSE 205, inputting the selection of the charging protocol by the operator, configuring the internal components 305 to provide electricity via the selected protocol by the EVSE 205, connecting the plug 305a to the EV 100 by the operator, transferring power from the EVSE 205 to the battery 140 by the EVSE 205, outputting a notification of state of charge by the EVSE 205, outputting a notification that the battery 140 is fully charged by the EVSE 205, disconnecting the plug 305a from the EV 100 by the operator, and outputting a notification that the charging process is complete by the EVSE 205. The intended steps may be preset by an operator of the EVSE 205 according to the functionality and programming of the EVSE 205. Some of the steps may be conditional on the completion of earlier steps or may occur simultaneously with other steps. Some of the steps in the foregoing example may be further subdivided.

The sequence of steps (as actually performed by the operator and the EVSE 205) may include a fault that interrupts the charging of the EV 100 by the EVSE 205. The term “fault” is used in its computing sense as an incorrect step in a process that is responsible for unintended behavior of a program or device. For example, a fault may occur because the EVSE 205 is unable to verify the payment information, the EVSE 205 cannot configure the internal components 305 for the selected protocol, the plug 305a is not connected or incorrectly connected to the EV 100, an incorrect plug 305a is connected to the EV 100, etc. The fault may cause the actual sequence of steps to deviate from the intended sequence of steps.

The computer 105, 110, 115 is programmed to track the sequence of steps of charging the EV 100 by the EVSE 205. The intended sequence of steps may be stored in the computer 105, 110, 115 as well as in a computing device of the EVSE 205. The computer 105, 110, 115 and/or the EVSE 205 may also store contingent intended steps that correspond to prespecified faults; in other words, a sequence of steps is intended to occur in response to a prespecified fault occurring. For example, the computer 105, 110, 115 may track the sequence of steps by determining the statuses of the steps, for example, which of the steps are completed, which of the steps are in progress or pending, and which of the steps are not yet pending. A step may be pending if the step is ready to be performed (e.g., if earlier steps necessary for that step are completed, and/or if other preconditions are satisfied). A step is not pending if the step has not been performed and is not ready to be performed (e.g., if a necessary earlier step is not complete, and/or if a precondition is not satisfied). The computer 105, 110, 115 may receive data from the EVSE 205 indicating the statuses of the steps, for example, indicating whenever a change in status of one of the steps occurs. The computer 105, 110, 115 may repeatedly or continuously update the statuses of the steps as actions are performed with respect to the EVSE 205.

As described below, the computer 105, 110, 115 generates handling operations for the user to handle the components 305 of the EVSE 205. For the purposes of this disclosure, a “handling operation” is defined as a step performed by a user in which the user handles something. For example, the handling operations for an operator of an EV 100 may include placing or inserting a payment card or mobile device into or onto the payment device 305c, typing information into the keypad 305d, plugging one of the plugs 305a into the port of the EV 100, placing the plug 305a back onto the physical structure 310, etc. For another example, the handling operations for a technician servicing the EVSE 205 may include removing or replacing a panel 305f, detaching or connecting wiring, adjusting internal components 305, etc. Accordingly, the handling operations support the steps of charging the EV 100 (i.e., cause progress from one step to the next). The handling operations may include handling operations responsive to a fault, such as using a different payment method after an attempted payment was unable to be verified, unplugging and replugging the plug 305a into the port of the EV 100 after electrical connections to the battery 140 of the EV 100 were not detected, etc.

The computer 105, 110, 115 is programmed to execute a large-language model (LLM) to generate the handling operations for the user to handle the components 305 of the EVSE 205. The term “large-language model” is used in its machine-learning sense of a computational model for natural language processing tasks. The LLM takes as input the sequence of steps (e.g., the current statuses of the steps or a most recent step performed), and the LLM provides as output a next handling operation. The handling operation as outputted by the LLM may take the form of a text instruction.

The LLM may be trained on training data that includes technical documentation of the EVSE 205. The technical documentation may include, for example, instruction manuals, service manuals, answers to frequently asked questions (FAQs), troubleshooting guides, etc. The LLM may thus be trained to provide handling operations consistent with the recommendations of the technical documentation for the EVSE 205. For example, the LLM may be a customized version of a preexisting foundation model. In other words, the LLM may be a foundation model that is already trained on a general-purpose corpus of text and that is then trained further on the technical documentation. The LLM may use any suitable foundation model as a base, for example, GPT, LLaMA, Claude, Gemini, Nemotron, etc.

The computer 105, 110, 115 may be programmed to determine a role of the user with respect to the EVSE 205. For the purposes of this disclosure, a “role” of a person is defined as a function or position (e.g., a job) of a person in some context. For example, roles that a user may have with respect to the EVSE 205 may include EV operator, repair technician, call-center technician, etc. The computer 105, 110, 115 may select the role from a preset group including at least EV operator and repair technician, and possibly also call-center technician. The computer 105, 110, 115 may determine the role of the user based on login information provided by the user. For example, the role may be stored in a profile or account of the user. The computer 105, 110, 115 may select EV operator in the absence of an indication that the user has a different role (i.e., EV operator is the default role).

The LLM may generate the handling operations specific to the role of the user. For example, the LLM may be trained to output handling operations based on data from an instruction manual in response to the role being EV operator, and output handling operations based on data from a service manual in response to the role being repair technician. At least some of the handling operations specific to the repair technician relate to components 305 of the EVSE 205 that are inaccessible to the EV operator. For example, in response to the role of the user being repair technician, the LLM may output handling operations for removing a panel 305f and adjusting wiring, circuit boards, transformers, computing devices, etc., inside the physical structure 310 of the EVSE 205. In response to the role being EV operator, the LLM may refrain from outputting handling operations for the panel 305f or internal components 305 of the EVSE 205.

The computer 105, 110, 115 is programmed to output the handling operations to the XR device 115. As a general overview, the computer 105, 110, 115 determines whether to output the handling operations in virtual reality or in augmented reality (e.g., based on a location of the user). When outputting the handling operations in VR or in AR, the XR device 115 displays the handling operations overlaid on the EVSE 205.

The XR device 115 displays the handling operations overlaid on the EVSE 205. The XR device 115 may output the handling operation at an apparent location corresponding to the component 305 of the EVSE 205 mentioned in the handling operation. The handling operation as outputted may include highlighting and/or an identifier of the component 305 mentioned in the handling operation. For example, the XR device 115 may display a handling operation to grab the plug 305a by highlighting and labeling the plug 305a, or the XR device 115 may display a handling operation to place a card on the payment reader by highlighting and labeling the payment reader, as shown in FIG. 3. The handling operations may be useful to the user, for example, to locate the payment device 305c, to distinguish the appropriate plug 305a (e.g., Level 1 versus Level 2 versus DCFC), etc. In the output, the highlighting and labeling appears overlaid on the EVSE 205. When outputting in virtual reality, the XR device 115 displays the handling operations overlaid on imagery of the EVSE 205. The imagery may be, for example, a recorded video or a computer-generated video.

When outputting in augmented reality, the XR device 115 displays the handling operations overlaid on a real-time display of the components 305 of the EVSE 205, in other words, a display of the EVSE 205 as the EVSE 205 currently exists in the physical world. For example,

the real-time display may be a video feed from a camera of the XR device 115 to a screen of the XR device 115 (in the case of a mobile device). For another example, the real-time display may be the EVSE 205 itself as seen through the lenses of AR glasses.

The computer 105, 110, 115 may be programmed to determine a location of the user. In particular, the computer 105, 110, 115 may determine whether the location of the user is at the EVSE 205 or away from the EVSE 205. The user may be at the EVSE 205 if the user is within reach of the EVSE 205 (e.g., when the EV 100 is parked at the parking space 210 corresponding to the EVSE 205). For example, the computer 105, 110, 115 may determine the location based on data from a GPS sensor of the sensors 125 of the EV 100 or a GPS sensor of the remote computer 110 (if a mobile device) or the XR device 115. The user may be at the EVSE 205 if the location from the GPS sensor is within a threshold distance of a known location of the EVSE 205 and away from the EVSE 205 otherwise. For another example, the computer 105, 110, 115 may determine whether the transceiver 135 of the EV 100 or the remote computer 110 (if a mobile device) or the XR device 115 is within range of a transmitter of the EVSE 205. The user may be at the EVSE 205 if the transceiver 135, remote computer 110, or XR device 115 is within range of the EVSE 205 and away from the EVSE 205 otherwise.

The computer 105, 110, 115 may be programmed to select virtual reality or augmented reality for outputting the handling operations based on the location of the user. The computer 105, 110, 115 may, in response to the location of the user being at the EVSE 205, output the handling operations in augmented reality. The computer 105, 110, 115 may, in response to the location of the user being away from the EVSE 205, output the handling operations in virtual reality.

Before a user (e.g., an EV operator) drives the EV 100 to the EVSE 205, the computer 105, 110, 115 may be programmed to help the user select the EVSE 205 and perform at least some of the sequence of steps. As a general overview, the computer 105, 110, 115 may display data on charging sites 200 and EVSEs 205, facilitate selection of an EVSE 205 at a charging site 200, and remotely instruct the selected EVSE 205 to perform a subset of the sequence of steps before the user arrives at the EVSE 205. The computer 105, 110, 115 can facilitate switching the selection to a different EVSE 205 in response to a fault occurring during the performance of the subset of steps.

The computer 105, 110, 115 may display data about charging sites 200 and/or EVSEs 205. For example, the user may input a request for nearby charging, and the computer 105, 110, 115 may display a listing of charging sites 200 and, in response to a selection of one of the charging sites 200, display detailed data about the selected charging site 200. The listing may be displayed as a list (e.g., in order of proximity), as a set of locations on a map, or both. The computer 105, 110, 115 may populate the listing with charging sites 200 within a driving range of the EV 100 (i.e., that the EV 100 is able to drive to using a current state of charge of the battery 140). The data about a charging site 200 may include, for example, number of EVSEs 205, occupancy of the EVSEs 205, rates of faults occurring with the EVSEs 205, travel time to the charging site 200, layout of the charging site 200, ratings or reviews of the charging site 200, etc. The XR device 115 may output a depiction of the charging site 200 in virtual reality along with a simulation of the handling operations, in the manner described above.

The user may select a charging site 200 (e.g., by consulting the data about the nearby charging sites 200) to use for charging the EV 100. The user may enter the selection using the user interface 130 or the remote computer 110. The user may further select an EVSE 205 at the charging site 200, or the computer 105, 110, 115 may select an EVSE 205 at the selected charging site 200 based on availability. The computer 105, 110, 115 may transmit a request to the charging site 200 to reserve the selected EVSE 205.

The computer 105, 110, 115 may be programmed to, in response to receiving the selection of the EVSE 205 while the user is located away from the EVSE 205, transmit a message to the EVSE 205 instructing the EVSE 205 to perform a subset of the sequence of steps. The subset of steps may include most or all of the steps before plugging the plug 305a into the EV 100 (or inductively transferring power). For example, the subset of steps may include processing payment data for the user and/or configuring the EVSE 205 for charging the EV 100. Further breaking down the steps, the subset of steps may include initiating the charging by the EV operator providing an input to the EVSE 205, outputting an instruction to provide payment by the EVSE 205, inputting payment information by the EV operator, receiving payment information by the EVSE 205, verifying the payment information by the EVSE 205, outputting an instruction to select a charging protocol by the EVSE 205, inputting the selection of the charging protocol by the EV operator, and configuring the internal components 305 to provide electricity via the selected protocol by the EVSE 205.

Furthermore, the computer 105, 110, 115 is programmed to, in response to receiving the selection of the EVSE 205 from a plurality of EVSEs 205, track the sequence of steps of charging the EV 100 by the EVSE 205, as described above. The tracking includes the steps performed before the user is at the EVSE 205 and after the user is at the EVSE 205.

By performing the subset of steps before the EV 100 is at the EVSE 205, the user may be able to switch to a different EVSE 205 or different charging site 200 altogether in case a fault occurs, rather than stopping the EV 100 at the EVSE 205 and then experiencing the fault. The computer 105, 110, 115 may be programmed to, in response to receiving an indication of a fault in performing the subset of steps, display a plurality of alternative EVSEs 205. For example, if a fault occurs in the payment processing or configuring the internal components 305, the EVSE 205 may transmit a notification to the computer 105, 110, 115. The computer 105, 110, 115 may output a message indicating the fault and display a listing of charging sites 200 or EVSEs 205 in the manner described above, excluding the previously selected EVSE 205 that experienced the fault.

The computer 105, 110, 115 and/or the EVSE 205 may, in response to an indication of a fault in performing the steps (either the subset of steps or the steps after the EV 100 is at the EVSE 205), transmit a report of the fault to a remote server. The report may include data about the circumstances of the fault, such as the identity of the EVSE 205, the identity of the EV 100, the step at which the fault occurred, data generated by sensors of the EVSE 205, data generated by sensors 125 of the EV 100, an error message returned by the EVSE 205, etc.

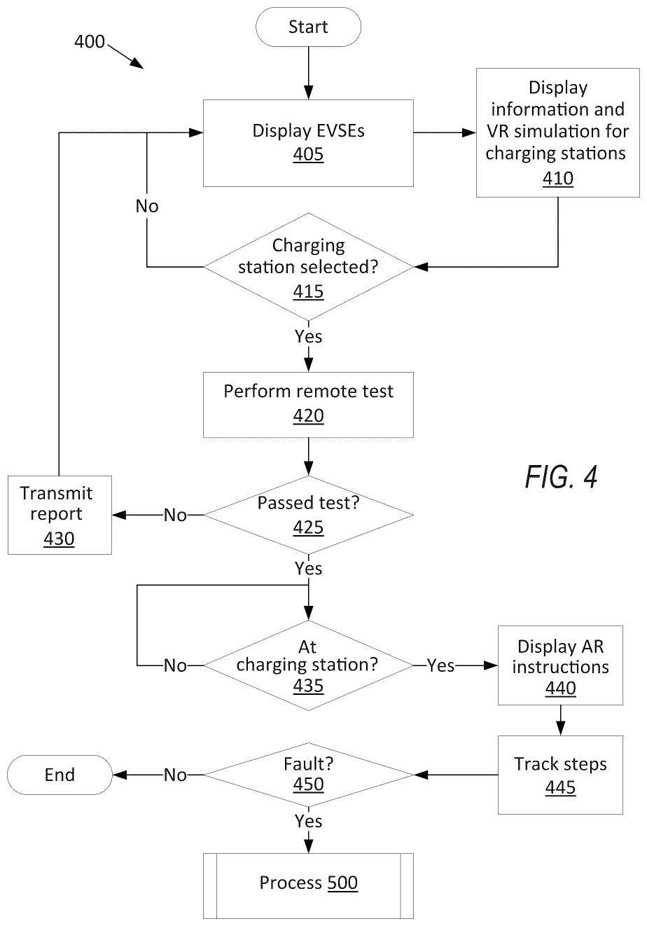

FIG. 4 is a flowchart illustrating an example process 400 for beginning the charging of the EV 100 at the charging site 200. The memory of the computer 105, 110, 115 stores executable instructions for performing the steps of the process 400 and/or programming can be implemented in structures such as mentioned above. As a general overview of the process 400, the computer 105, 110, 115 displays a plurality of EVSEs 205 at a plurality of charging sites 200 while the user is browsing through the charging sites 200. In response to receiving a selection of the EVSE 205, the computer 105, 110, 115 transmits a message to the selected EVSE 205 to perform a subset of the sequence of steps. In response to a fault, the computer 105, 110, 115 transmits a report and returns to browsing alternative EVSEs 205. In response to the subset of steps being successfully performed, the computer 105, 110, 115 executes the LLM to generate handling operations in augmented reality. The sequence of steps is performed for charging the EV 100. In response to a fault occurring, the computer 105, 110, 115 proceeds to a process 500 described below. Otherwise, the process 400 ends.

The process 400 begins in a block 405, in which the computer 105, 110, 115 displays a plurality of alternative EVSEs 205, as described above.

Next, in a block 410, the computer 105, 110, 115 displays data about a charging site 200 selected from the listing, including a VR simulation of the charging site 200, as described above.

Next, in a decision block 415, the computer 105, 110, 115 determines whether an EVSE 205 has been selected as described above. In response to receiving a selection of the EVSE 205 while the user is located away from the EVSE 205, the process 400 proceeds to a block 420. Otherwise, the process 400 returns to the block 405 for the user to continue browsing the charging sites 200.

In the block 420, the computer 105, 110, 115 transmits a message to the selected EVSE 205 instructing the selected EVSE 205 to perform the subset of the sequence of steps, as described above.

Next, in a decision block 425, the computer 105, 110, 115 determines whether a fault occurred during the performance of the subset of steps, as described above. In response to receiving an indication of a fault in performing the subset, the process 400 proceeds to a block 430. In response to the subset of steps being completed without an indication of a fault, the process 400 proceeds to a decision block 435.

In the block 430, the computer 105, 110, 115 transmits a report to a remote server, as described above. After the block 430, the process 400 returns to the block 405 to browse alternative EVSEs 205.

In the decision block 435, the computer 105, 110, 115 determines whether the user is at the EVSE 205, as described above. In response to the user being at the EVSE 205, the process 400 proceeds to a block 440. In response to the user still being away from the EVSE 205, the process 400 remains at the decision block 435 to wait for the user to arrive at the EVSE 205.

In the block 440, the computer 105, 110, 115 executes the LLM to generate the handling operations for the user to handle the components 305 of the EVSE 205. The computer 105, 110, 115 instructs the XR device 115 to output the handling operations in augmented reality overlaid on a real-time display of the components 305 of the EVSE 205, as described above.

Next, in a block 445, the computer 105, 110, 115 tracks the sequence of steps as the power transfer occurs, as described above.

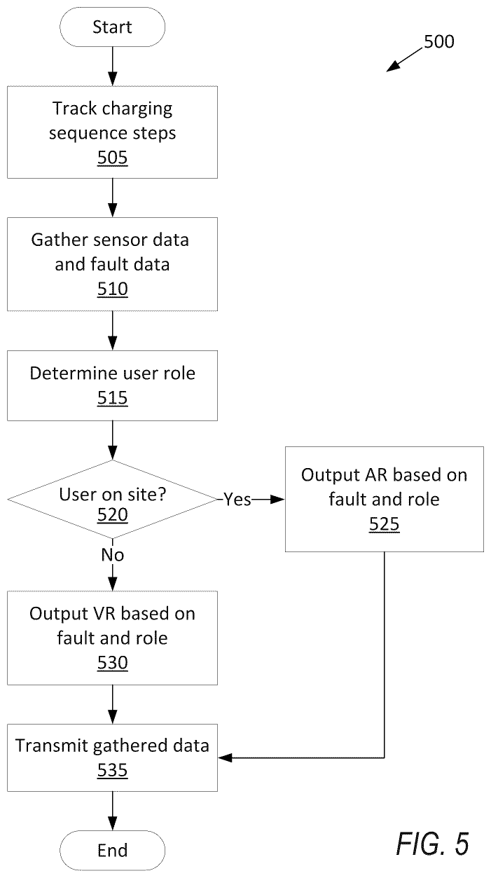

Next, in a decision block 450, the computer 105, 110, 115 determines whether a fault occurred while the vehicle is at the EVSE 205, as described above. In response to a fault occurring, the computer 105, 110, 115 executes the process 500, described below with respect to FIG. 5. In response to the charging completing without a fault, the process 400 ends.

FIG. 5 is a flowchart illustrating an example process 500 for addressing a fault during the charging of the EV 100. The memory of the computer 105, 110, 115 stores executable instructions for performing the steps of the process 500 and/or programming can be implemented in structures such as mentioned above. The user for which the process 500 is executed may be the EV operator who experienced the fault or a repair technician or call-center technician addressing a fault that occurred to a different user. As a general overview of the process 500, the computer 105, 110, 115 tracks the sequence of steps, gathers sensor data and fault data, and determines the role of the user. In response to the user being at the EVSE 205, the computer 105, 110, 115 outputs the handling operations in augmented reality. In response to the user being away from the EVSE 205, the computer 105, 110, 115 outputs the handling operations in virtual reality. Finally, the computer 105, 110, 115 transmits the gathered data in a report to the remote server.

The process 500 begins in a block 505, in which the computer 105, 110, 115 tracks the sequence of the steps performed in charging the EV 100 by the EVSE 205, as described above.

Next, in a block 510, the computer 105, 110, 115 receives data from sensors and the EVSE 205 indicating that a fault occurred. The data includes data from the sensors 125 of the EV 100 and from sensors of the EVSE 205 generated contemporaneously with the fault occurring, the statuses of the steps of charging the EV 100, error messages generated by the EVSE 205, etc.

Next, in a block 515, the computer 105, 110, 115 determines the role of the user with respect to the EVSE 205, as described above.

Next, in a decision block 520, the computer 105, 110, 115 determines the location of the user, as described above. In response to the location of the user being at the EVSE 205, the process 500 proceeds to a block 525. In response to the location of the user being away from the EVSE 205, the process 500 proceeds to a block 530.

In the block 525, the computer 105, 110, 115 executes the LLM to generate the handling operations for the user to handle the components 305 of the EVSE 205. The LLM outputs handling operations for addressing the fault. The computer 105, 110, 115 instructs the XR device 115 to output the handling operations in augmented reality overlaid on a real-time display of the components 305 of the EVSE 205, as described above. After the block 525, the process 500 proceeds to a block 535.

In the block 530, the computer 105, 110, 115 executes the LLM to generate the handling operations for the user to handle the components 305 of the EVSE 205. The LLM outputs handling operations for addressing the fault. The computer 105, 110, 115 instructs the XR device 115 to output the handling operations in virtual reality overlaid on imagery of the components 305 of the EVSE 205, as described above. After the block 530, the process 500 proceeds to a block 535.

In the block 535, the computer 105, 110, 115 transmits a report to a remote server, as described above. After the block 535, the process 500 ends.

In general, the computing systems and/or devices described may employ any of a number of computer operating systems, including, but by no means limited to, versions and/or varieties of the Ford Sync@ application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™M, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions (e.g., from a memory, a computer readable medium, etc.) and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Operations, systems, and methods described herein should always be implemented and/or performed in accordance with an applicable owner's/user's manual and/or safety guidelines.

The disclosure has been described in an illustrative manner, and it is to be understood that the terminology which has been used is intended to be in the nature of words of description rather than of limitation. Use of “in response to,” “upon determining,” etc. indicates a causal relationship, not merely a temporal relationship. Many modifications and variations of the present disclosure are possible in light of the above teachings, and the disclosure may be practiced otherwise than as specifically described.

1. A computer comprising a processor and a memory, the memory storing instructions executable by the processor to:
in response to receiving a selection of electric vehicle service equipment (EVSE) while a user is located away from the EVSE, transmit a message to the EVSE instructing the EVSE to perform a subset of a sequence of steps of charging an electric vehicle (EV);
track the sequence of steps of charging the EV by the EVSE;
in response to receiving an indication of a fault in performing the subset of the sequence of steps by the EVSE while the user is located away from the EVSE, display a plurality of alternative EVSEs;
execute a large-language model (LLM) to generate handling operations for the user to handle components of the EVSE, the handling operations supporting the steps of charging the EV; and
output the handling operations to an extended-reality (XR) device, the XR device displaying the handling operations overlaid on the EVSE, the XR device highlighting the components of the EVSE that are in the handling operations;
wherein the subset of the sequence of steps includes configuring internal components of the EVSE to provide electricity from the EVSE to the EV via a charging protocol.

2. The computer of claim 1, wherein the sequence of steps includes the fault that interrupts the charging of the EV by the EVSE, and at least one of the handling operations is responsive to the fault.

3. The computer of claim 1, wherein the XR device is an augmented-reality (AR) device, and the AR device displays the handling operations overlaid on a real-time display of the components of the EVSE.

4. The computer of claim 1, wherein the instructions further include instructions to determine a role of the user with respect to the EVSE, and the LLM generates the handling operations specific to the role of the user.

5. The computer of claim 4, wherein the instructions further include instructions to select the role from a preset group including at least EV operator and repair technician.

6. The computer of claim 5, wherein at least some of the handling operations specific to the repair technician relate to the components of the EVSE that are inaccessible to the EV operator.

7. The computer of claim 5, wherein the preset group includes call-center technician.

8. The computer of claim 1, wherein the instructions further include instructions to, in response to a location of the user being at the EVSE, output the handling operations in augmented reality.

9. The computer of claim 1, wherein the instructions further include instructions to, in response to a location of the user being away from the EVSE, output the handling operations in virtual reality.

10. (canceled)

11. The computer of claim 1, wherein the subset includes processing payment data for the user.

12. (canceled)

13. The computer of claim 1, wherein the LLM is trained on training data that includes technical documentation of the EVSE.

14. The computer of claim 1, wherein the instructions further include instructions to, in response to receiving the selection of the EVSE from the plurality of EVSEs, track the sequence of steps of charging the EV by the EVSE.

15. A method comprising:
in response to receiving a selection of electric vehicle service equipment (EVSE) while a user is located away from the EVSE, transmitting a message to the EVSE instructing the EVSE to perform a subset of a sequence of steps of charging an electric vehicle (EV);
tracking the sequence of steps of charging the EV by the EVSE;
in response to receiving an indication of a fault in performing the subset of the sequence of steps by the EVSE while the user is located away from the EVSE, displaying a plurality of alternative EVSEs;
executing a large-language model (LLM) to generate handling operations for the user to handle components of the EVSE, the handling operations supporting the steps of charging the EV; and
outputting the handling operations to an extended-reality (XR) device, the XR device displaying the handling operations overlaid on the EVSE, the XR device highlighting the components of the EVSE that are in the handling operations;
wherein the subset of the sequence of steps includes configuring internal components of the EVSE to provide electricity from the EVSE to the EV via a charging protocol.

16. The method of claim 15, wherein the sequence of steps includes the fault that interrupts the charging of the EV by the EVSE, and at least one of the handling operations is responsive to the fault.

17. The method of claim 15, further comprising determining a role of the user with respect to the EVSE, wherein the LLM generates the handling operations specific to the role of the user.

18. The method of claim 17, further comprising selecting the role from a preset group including at least EV operator and repair technician.

19. The method of claim 15, further comprising, in response to a location of the user being at the EVSE, outputting the handling operations in augmented reality.

20. The method of claim 15, further comprising, in response to a location of the user being away from the EVSE, outputting the handling operations in virtual reality.

21. The computer of claim 1, wherein the sequence of steps includes receiving a selection of the charging protocol.

22. The computer of claim 1, wherein the fault includes that the EVSE cannot configure the internal components for the charging protocol.
